(19) United States
(12) Patent Application Publication
(10) Pub. No.: US 2013/0142298 A1
(43) Pub. Date: Jun. 6, 2013

(54) IN-CORE NUCLEAR INSTRUMENTATION APPARATUS

(71) Applicants: Toshihiko NAKANOSONO, Chiyoda-ku (JP); Masaru Tamuro, Tokyo (JP)

(72) Inventors: Toshihiko NAKANOSONO, Chiyoda-ku (JP); Masaru Tamuro, Tokyo (JP)

(73) Assignee: Mitsubishi Electric Corporation, Chiyoda-ku (JP)

(21) Appl. No.: 13/447,601

(22) Filed: Apr. 16, 2012

(30) Foreign Application Priority Data
Dec. 6, 2011 (JP) 2011-266367

(51) Int. Cl. G21C 17/108

(52) U.S. Cl. 376/259

(57) ABSTRACT

An in-core nuclear instrumentation apparatus is provided with a neutron flux current detection circuit which converts a neutron flux current signal fed from a neutron detector into a voltage signal and amplifies the voltage signal with a capability to continuously vary amplifier gain. The neutron flux current detection circuit includes a current sensing resistor for converting the neutron flux current signal into the voltage signal, an amplifier for amplifying the voltage signal, wherein an equivalent resistance value of a feedback circuit of the amplifier can be controllably varied, an equivalent resistance control circuit for varying the equivalent resistance value of the feedback circuit, and an output circuit which outputs an output terminal voltage signal of the amplifier.

### BACKGROUND OF THE INVENTION

1. Field of the Invention

The present invention relates to an in-core nuclear instrumentation apparatus for monitoring neutrons within a nuclear reactor of a light water reactor nuclear power plant.

2. Description of the Background Art

Conventionally, pressurized and boiling water reactors are structured to each include an in-core nuclear instrumentation system for measuring the distribution of power within a reactor core. An in-core nuclear instrumentation apparatus of the system performs measurement of neutron flux within the reactor core in the following way. A movable neutron detector is remotely controlled to move within a thimble mounted on the inside of the reactor core to measure the neutron flux distribution therewithin as described in Japanese Laid-open Patent Application No. 2006-145417, for example.

Typically, the neutron flux in the reactor core can vary on the order of three to five digits in terms of sensing ranges and detected electric currents are extremely small. Thus, a conventional method used for selecting a desired sensing range for neutron flux measurement is to switch among a plurality of sensing ranges by switching multistage current sensing resistors by means of a relay as described in Japanese Laid-open Patent Application No. 1986-100661, for example.

The conventional in-core nuclear instrumentation apparatus for measuring the neutron flux within the reactor core allows a choice of sensing ranges by use of a plurality of current sensing resistors. It has been a common practice for the in-core nuclear instrumentation apparatus to employ a mercury relay having a low contact resistance, which provides high measuring accuracy for extremely small electric currents, as well as a long service life. One problem of this type of nuclear instrumentation system is that mercury relays are difficult to procure nowadays.

An alternative type of relay, if any, has a high contact resistance and is apt to form an oxide layer. An alternative type of relay is therefore difficult to use in a stable fashion and requires replacements at short time intervals owing to a shorter service life of relay contacts as compared to a mercury relay. It is also difficult to employ semiconductor switching devices instead of mercury relays. This is because an “on” voltage of a semiconductor device adversely affects current sensing accuracy of an in-core nuclear instrumentation apparatus employing the semiconductor device.

Moreover, as the number of fixed resistors is limited due to limitations in space for arranging the fixed resistors, it is necessary to measure a current by using one of upper ranges which provides a lower sensing resolution when performing current measurement near a boundary between adjacent sensing ranges in order to unify sensing ranges of a plurality of detectors.

### SUMMARY OF THE INVENTION

The present invention has been made to solve the aforementioned problems of the prior art. Accordingly, it is an object of the invention to provide an in-core nuclear instrumentation apparatus including a single current sensing resistor which eliminates the need for a moving part as well as a circuit configured to variably amplify a voltage which is converted from a measured current.

An in-core nuclear instrumentation apparatus according to the present invention includes a neutron flux current detection circuit which converts a neutron flux current signal fed from a neutron detector into a voltage signal and amplifies the voltage signal with a capability to continuously vary amplifier gain. The in-core nuclear instrumentation apparatus is configured to measure the distribution of power within a nuclear reactor using the voltage signal output from the neutron flux current detection circuit.

The in-core nuclear instrumentation apparatus of the invention includes the neutron flux current detection circuit which converts the neutron flux current signal fed from the neutron detector into the voltage signal and amplifies the voltage signal with the capability to continuously vary the amplifier gain, the in-core nuclear instrumentation system being configured to measure the distribution of power within the nuclear reactor using the voltage signal output from the neutron flux current detection circuit as mentioned above. Therefore, a circuit for selecting one of current sensing ranges does not include any moving part. This configuration of the invention makes it possible to continuously vary the amplifier gain and provide an improved flux sensing resolution, yet providing an extended operational life of the in-core nuclear instrumentation apparatus.

The foregoing and other objects, features, aspects and advantages of the present invention will become more apparent from the following detailed description when read in conjunction with the accompanying drawings.

### BRIEF DESCRIPTION OF THE DRAWINGS

FIG. 1 is a system configuration diagram of an in-core nuclear instrumentation apparatus according to a first embodiment of the invention;

FIG. 2 is a configuration diagram of a principal neutron flux measuring portion of the in-core nuclear instrumentation apparatus of the first embodiment; and

FIG. 3 is a flowchart depicting a process flow of neutron flux measurement performed by the in-core nuclear instrumentation apparatus of the first embodiment.

### DETAILED DESCRIPTION OF THE PREFERRED EMBODIMENT OF THE INVENTION

### First Embodiment

An in-core nuclear instrumentation apparatus 1 according to a first embodiment of the present invention is provided with a circuit for converting a neutron flux current signal fed from a neutron detector into a voltage signal, the circuit including a neutron flux current detection circuit capable of continuously varying amplifier gain but not including a moving part for selecting one of current sensing ranges.

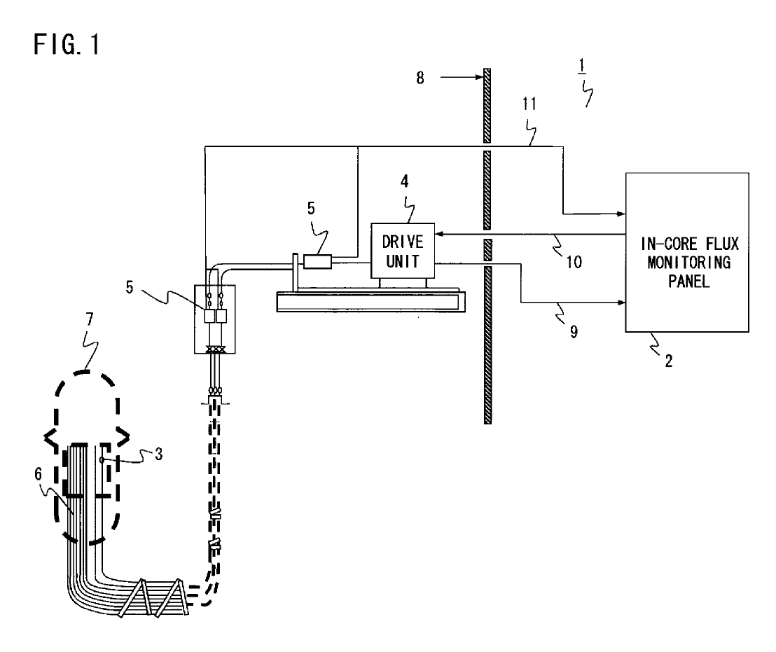

The configuration, operation and functions of the in-core nuclear instrumentation apparatus 1 of the first embodiment are described hereinbelow with reference to FIGS. 1, 2 and 3 which are a system configuration diagram of the in-core nuclear instrumentation apparatus 1, a configuration diagram of a principal neutron flux measuring portion and a flowchart depicting a process flow of neutron flux measurement, respectively.

An in-core nuclear instrumentation system including the in-core nuclear instrumentation apparatus 1 according to the first embodiment of the invention is described in detail with reference to FIG. 1 which is a diagram generally depicting the configuration of the in-core nuclear instrumentation system used for a pressurized water reactor. The in-core nuclear instrumentation system which is centered around the in-core nuclear instrumentation apparatus 1 is associated with a reactor vessel 7 accommodating a nuclear reactor that is an object of measurement and a containment vessel 8 in which main primary facilities (not shown), such as a pressurizer and a primary coolant pump, are installed. The reactor vessel 7 and the containment vessel 8 are major constituent facilities of the in-core nuclear instrumentation system.

Generally, measurement of the distribution of power within the nuclear reactor of the pressurized water reactor is performed by measuring neutron flux within a reactor core. The neutron detector is remotely controlled to move within a thimble mounted on the inside of the reactor core to measure the neutron flux distribution in the reactor core.

Referring to FIG. 1, the in-core nuclear instrumentation apparatus 1 includes a movable neutron detector 3 for detecting neutron flux within the reactor core in the reactor vessel 7, an in-core flux monitoring panel 2 used for remotely controlling such operations as detection, monitoring and data storage of the neutron flux signal fed from the neutron detector 3 as well as movements (insertion and extraction) of the movable neutron detector 3, a plurality of thimbles 6 which provide passages for the neutron detector 3 inserted into the reactor core in the reactor vessel 7, a drive unit 4 for driving the neutron detector 3 to move within one of the thimbles 6 for insertion and/or extraction of the neutron detector 3, and a passage selection unit 5 which determines one of the thimbles 6 in which the neutron detector 3 is to be moved. While the in-core flux monitoring panel 2 is mounted outside the containment vessel 8, the other devices of the in-core nuclear instrumentation apparatus 1 including the drive unit 4 are installed within the containment vessel 8.

The neutron detector 3 is a movable fission ionization chamber which is typically used for neutron flux detection. A high DC voltage is applied to the neutron detector 3 in order to ionize gas filled therein by incident neutrons. The applied high DC voltage is set at a level at which the neutron detector 3 presents a curve showing plateau characteristics so that a value obtained by dividing a detected current by neutron flux density would not be affected by fluctuations of the applied high voltage.

Operations for insertion and extraction of the neutron detector 3 into and from the nuclear reactor are now described referring also to transmission/reception of signals between the in-core nuclear instrumentation apparatus 1 and the neutron detector 3, the drive unit 4 and the passage selection unit 5.

When the in-core flux monitoring panel 2 for controlling and monitoring the in-core nuclear instrumentation system outputs an insertion command 10 to the drive unit 4 and the passage selection unit 5, the passage selection unit 5 located within the containment vessel 8 selects a detector passage and the drive unit 4 performs operation for inserting the movable neutron detector 3 into the specified thimble 6 provided in the reactor vessel 7. The passage selection unit 5 outputs a passage selection signal 11 indicating which one of the passages is currently selected to the in-core flux monitoring panel 2.

A neutron flux signal 9 output from the neutron detector 3 inserted into the reactor core provided within the reactor vessel 7 is input into the in-core flux monitoring panel 2, whereby the in-core flux monitoring panel 2 performs signal processing operation to measure the neutron distribution within the reactor core.

When the neutron detector 3 inserted into the selected thimble 6 reaches a far end thereof while measuring the neutron distribution within the reactor core, the in-core flux monitoring panel 2 outputs an extraction command 10 to the drive unit 4 and, as a result, the neutron detector 3 is extracted from the reactor vessel 7 back to the passage selection unit 5.

When the in-core flux monitoring panel 2 outputs the insertion command 10 for another thimble 6 to the drive unit 4 and the passage selection unit 5 subsequently, the passage selection unit 5 located within the containment vessel 8 selects a detector passage and the drive unit 4 performs operation for inserting the movable neutron detector 3 into the specified thimble 6 provided in the reactor vessel 7.

While the in-core nuclear instrumentation apparatus 1 has thus far been described as including a single neutron detector 3, the in-core nuclear instrumentation apparatus 1 of the embodiment is provided with a plurality of neutron detectors 3 in actuality. Specifically, the in-core nuclear instrumentation apparatus 1 is so configured as to drive three or four neutron detectors 3 at the same time through a corresponding number of thimbles 6 provided in the reactor core.

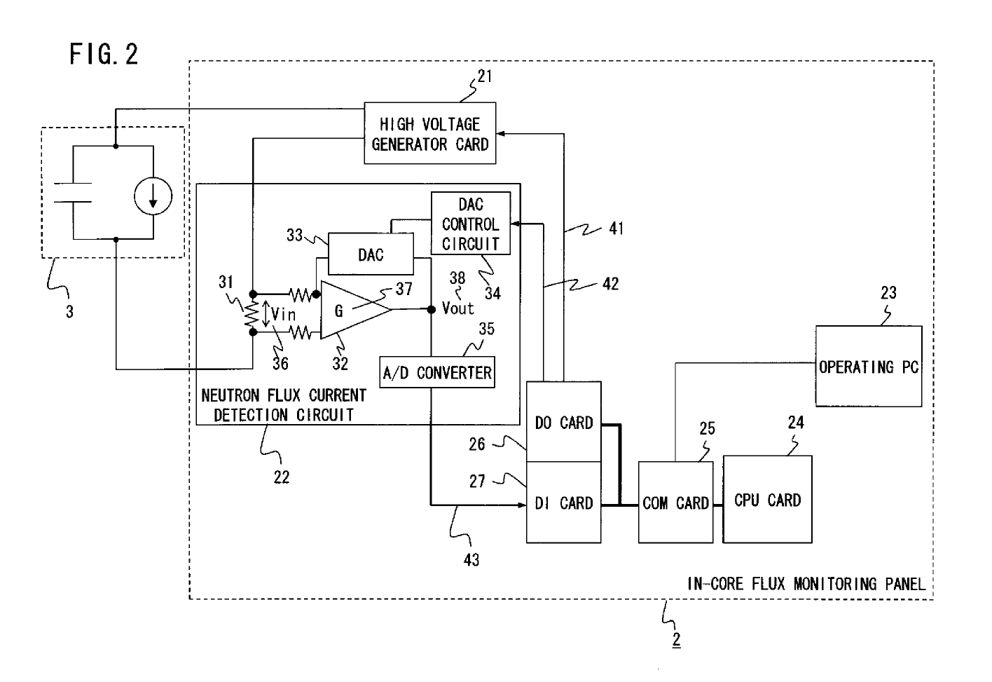

The configuration, operation and functions of the principal neutron flux measuring portion of the in-core nuclear instrumentation apparatus 1 are now described below with reference to FIG. 2.

The principal neutron flux measuring portion is configured as illustrated in FIG. 2, including a high voltage generator card 21, a neutron flux current detection circuit 22, an operating personal computer (PC) 23, a central processing unit (CPU) card 24, a digital output (DO) card 26 and a digital input (DI) card 27. The high voltage generator card 21 applies the high DC voltage to the neutron detector 3. The neutron flux current detection circuit 22 converts a neutron flux current signal fed from the neutron detector 3 into a voltage signal and amplifies the voltage signal. The operating PC 23 allows an operator to monitor the neutron flux distribution in the reactor core using the neutron flux signal fed from the neutron detector 3 and to perform the operations for insertion and extraction of the neutron detector 3 into and from the nuclear reactor. The CPU card 24 is used when processing the neutron flux signal from the neutron detector 3 and executing commands for insertion and extraction of the neutron detector 3 entered from the operating PC 23 in accordance with a preprogrammed processing procedure via a communications card 25. The digital output card 26 and the digital input card 27 are used when setting the high DC voltage in the high voltage generator card 21 and when the operating PC 23 transmits and/or receives later-described signals to and from the neutron flux current detection circuit 22.

As depicted in FIG. 2, the high voltage generator card 21, the neutron flux current detection circuit 22, the operating PC 23, the CPU card 24, the communications card 25, the digital output card 26 and the digital input card 27 are provided together in the in-core flux monitoring panel 2. The operating PC 23 may however be located outside the in-core flux monitoring panel 2. For example, the operating PC 23 may be situated in a main control board so that the operator can monitor the neutron flux distribution and perform the operations for insertion and extraction of the neutron detector 3 into and from the nuclear reactor on the main control board.

Described in the following is how the neutron flux current detection circuit 22 is configured. The neutron flux current detection circuit 22 includes a current sensing resistor 31, an amplifier 32, a digital-to-analog converter (DAC) 33, a DAC control circuit 34 and an analog-to-digital (A/D) converter 35. The current sensing resistor 31 converts the neutron flux current signal fed from the neutron detector 3 into a voltage signal and the amplifier 32 amplifies this voltage signal. The DAC 33 functions as equivalent resistance of a feedback circuit of the amplifier 32. The DAC control circuit 34 works as an equivalent resistance control circuit for varying the equivalent resistance of the feedback circuit of the amplifier 32 by controlling the DAC 33 in accordance with an amplifier gain control signal 42 fed from the digital output card 26. The A/D converter 35 is an output circuit which outputs an output terminal voltage signal of the amplifier 32. Here, an output signal of the A/D converter 35 has a value obtained by converting a current value detected by the neutron detector 3 into the voltage signal and amplifying the value of the voltage signal. This means that the output signal of the A/D converter 35 is a signal 43 corresponding to the current value detected by the neutron detector 3.

In the following discussion, an input voltage 36 of the amplifier 32 obtained by converting the neutron flux current signal fed from the neutron detector 3 by the current sensing resistor 31 is denoted by Vin and an output terminal voltage 38 of the amplifier 32 is denoted by Vout.

Described below is how the amplifier 32, the DAC 33 that functions as the equivalent resistance of the feedback circuit and the DAC control circuit 34 serving as the equivalent resistance control circuit operate.

The DAC control circuit 34 continuously varies gain G37 of the amplifier 32 by controlling the value of the equivalent resistance of the feedback circuit which is output from the DAC 33 provided in the feedback circuit of the amplifier 32 in accordance with the amplifier gain control signal 42 fed from the operating PC 23 by way of the digital output card 26. The amplifier 32 amplifies the input voltage Vin 36 having a value corresponding to a detector current detected by the current sensing resistor 31 to the output terminal voltage Vout 38 by the gain G37. The output terminal voltage Vout 38 thus obtained is converted from analog form into digital form by the A/D converter 35 and the A/D-converted voltage is read into the digital input card 27 as the signal 43 corresponding to the current value detected by the neutron detector 3, which is then processed by the CPU card 24.

The aforementioned high voltage generator card 21 operates as follows. A high DC voltage setup value entered from the operating PC 23 is output from the CPU card 24 as a high voltage setup signal 41 to the high voltage generator card 21 through the digital output card 26 for setting a high DC voltage value. The high voltage generator card 21 generates the high DC voltage in accordance with the input high DC voltage value and applies the high DC voltage to the neutron detector 3.

While the principal neutron flux measuring portion has thus far been described as including one each high voltage generator card 21 and neutron flux current detection circuit 22 only and so illustrated in FIG. 2, the principal neutron flux measuring portion is provided with a plurality of high voltage generator cards 21 and neutron flux current detection circuits 22 corresponding to the number of the simultaneously operated neutron detectors 3 in actuality. This makes it possible to operate the aforementioned plurality of neutron detectors 3 and measure neutron flux current signals at a plurality of points within the reactor at the same time.

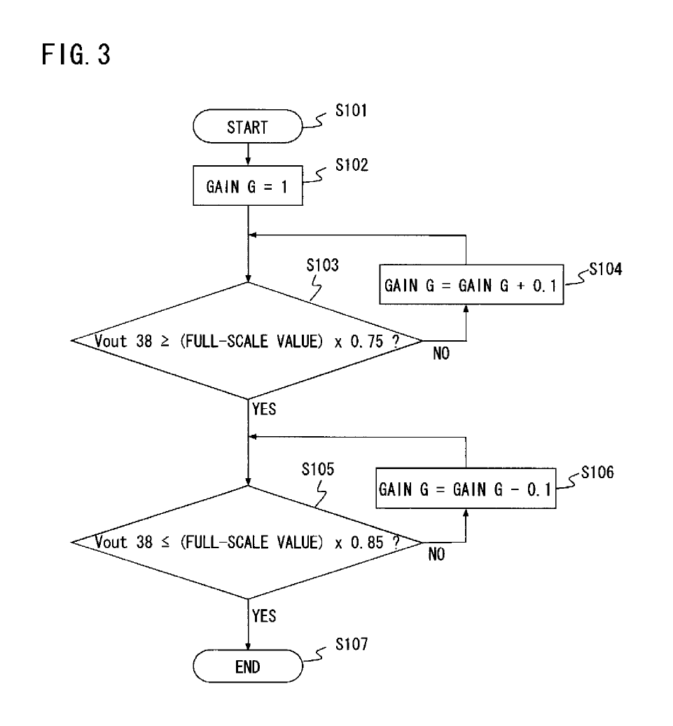

During a process of monitoring the neutron flux distribution in the reactor core on a screen of the operating PC 23, the gain G37 of the amplifier 32 of the neutron flux current detection circuit 22 is varied and so determined in accordance with the neutron flux measurement process flow depicted in FIG. 3.

The value of a full scale of the output terminal voltage Vout 38 of the amplifier 32 presented on the operating PC 23 of FIG. 2 is 4,000 provided that the output signal of the A/D converter 35 is expressed by an 8-bit value and the full scale presented on-screen covers a maximum range of 0 to 4,000.

Now, the neutron flux measurement process flow followed by the principal neutron flux measuring portion of the in-core nuclear instrumentation apparatus 1 is described with reference to the flowchart of FIG. 3.

The in-core nuclear instrumentation apparatus 1 divides the value of the output terminal voltage Vout 38 by the full-scale value and performs such a control operation that a value obtained by this division falls within a predetermined range (0.75-0.85).

Upon initiating the process flow (step S101), the in-core nuclear instrumentation apparatus 1 sets an initial value of the amplifier gain as G=1 in step S102. Then, in step S103, the in-core nuclear instrumentation apparatus 1 compares the output terminal voltage Vout 38 with the full-scale value to determine whether a state “A” expressed by Vout≧(full-scale value)×0.75 is satisfied. If the state “A” is satisfied, the in-core nuclear instrumentation apparatus 1 proceeds to step S105. If the state “A” is not satisfied, the in-core nuclear instrumentation apparatus 1 proceeds to step S104 to increment the amplifier gain G by 0.1 and then returns to step S103.

In succeeding step S105, the in-core nuclear instrumentation apparatus 1 compares the output terminal voltage Vout 38 with the full-scale value to determine whether a state “B” expressed by Vout≦(full-scale value)×0.85 is satisfied. If the state “B” is satisfied, the in-core nuclear instrumentation apparatus 1 terminates the process flow (step S107). If the state “B” is not satisfied, the in-core nuclear instrumentation apparatus 1 decrements the amplifier gain G by 0.1 and then returns to step S105.

As a result of the above-described processing operation, the gain G37 of the amplifier 32 provided in the neutron flux current detection circuit 22 is so adjusted that the current value detected by the neutron detector 3 is indicated within a range of 75% to 85% of the full scale presented on the screen of the operating PC 23 to facilitate monitoring.

It is to be pointed out that the aforementioned presentation range defined by a lower limit of 75% and an upper limit of 85% is illustrative. In practice, the lower and upper limits of the presentation range may be redefined in a manner that allows the operator to easily monitor the neutron flux distribution depending on specific situations.

Since the plurality of neutron detectors 3 can be simultaneously operated in the in-core nuclear instrumentation apparatus 1 of this embodiment, the operator is allowed to present and monitor a plurality of neutron flux currents detected by the neutron detectors 3 on the screen of the operating PC 23 at the same time.

If the operator is to simultaneously present and monitor a plurality of neutron flux currents detected by the neutron detectors 3 on the screen of the operating PC 23 by the earlier-mentioned conventional monitoring method in which a mercury relay is used to switch among a plurality of current sensing resistors, there can be a case where the operator has no choice but to select an upper range which provides a lower sensing resolution owing to differences in the properties of the individual neutron detectors 3. The in-core nuclear instrumentation apparatus 1 of the present invention does not suffer from this problem, however, because there is provided the single current sensing resistor 31 only which is used for continuously varying the amplifier gain.

As thus far described, the in-core nuclear instrumentation apparatus 1 of the present embodiment includes the circuit for converting the neutron flux current signal fed from the neutron detector into a voltage signal, the circuit including the neutron flux current detection circuit capable of continuously varying the amplifier gain but not having a circuit including a moving part for selecting one of current sensing ranges. This configuration of the invention makes it possible to continuously vary the amplifier gain and provide an improved flux sensing resolution as well as an extended operational life of the in-core nuclear instrumentation apparatus 1.

Various modifications and alterations of the in-core nuclear instrumentation apparatus of this invention will be apparent to those skilled in the art without departing from the scope and spirit of the invention, and it should be understood that this is not limited to the illustrative embodiment set forth herein.

What is claimed is:

1. An in-core nuclear instrumentation apparatus comprising a neutron flux current detection circuit which converts a neutron flux current signal fed from a neutron detector into a voltage signal and amplifies the voltage signal with a capability to continuously vary amplifier gain, said in-core nuclear instrumentation apparatus being configured to measure the distribution of power within a nuclear reactor using the voltage signal output from said neutron flux current detection circuit.

2. The in-core nuclear instrumentation apparatus according to claim 1, said neutron flux current detection circuit including:
a current sensing resistor for converting the neutron flux current signal fed from said neutron detector into the voltage signal;
an amplifier for amplifying the voltage signal converted from the neutron flux current signal by said current sensing resistor, wherein an equivalent resistance value of a feedback circuit of said amplifier can be controllably varied;
an equivalent resistance control circuit for varying the equivalent resistance value of the feedback circuit; and
an output circuit which outputs an output terminal voltage signal of said amplifier.

3. The in-core nuclear instrumentation apparatus according to claim 2, wherein said neutron flux current detection circuit compares the value of the output terminal voltage signal of said amplifier with a full-scale value of a range in which the neutron flux current signal is monitored and controls the equivalent resistance value of the feedback circuit of said amplifier so that a value obtained by dividing the value of the output terminal voltage signal by the full-scale value falls within a predetermined range.
